(19) United States
(12) Patent Application Publication
(10) Pub. No.: US 2026/0181702 A1
(43) Pub. Date: Jun. 25, 2026

(54) ADDITIONAL RANDOM ACCESS CHANNEL OCCASION SUBSET ACTIVATION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US)

(21) Appl. No.: 18/990,739

(22) Filed: Dec. 20, 2024

(51) Int. Cl. H04W 74/0833; H04L 5/00; H04W 72/232

(52) U.S. Cl. CPC H04W 74/0833; H04L 5/0048; H04W 72/232

(57) ABSTRACT

Certain aspects of the present disclosure provide techniques activating one or more subsets of additional random access channel (RACH) occasions. An exemplary method performed by a user equipment (UE) includes receiving first RACH configuration information configuring a plurality of RACH configuration periods and a plurality of legacy RACH occasions (ROs), receiving second RACH configuration information configuring a plurality of additional ROs, wherein second RACH configuration information defines the plurality of additional ROs relative to the plurality of legacy ROs, receiving downlink control information (DCI) indicating a set of additional ROs from the plurality of additional ROs and a subset of additional ROs that are activated, in the indicated set of additional ROs, for use by the UE, and transmitting a RACH transmission in at least one legacy RO of the plurality of legacy ROs or in at least one additional RO of the subset of additional ROs.

### FIELD OF THE DISCLOSURE

Aspects of the present disclosure relate to wireless communications, and more particularly, to techniques for activating one or more subsets of additional random access channel (RACH) occasions.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs; receiving second RACH configuration information configuring a plurality of additional ROs in one or more RACH configuration periods of the plurality of RACH configuration periods, wherein the second RACH configuration information defines the plurality of additional ROs relative to the plurality of legacy ROs; receiving downlink control information (DCI) indicating: a set of additional ROs from the plurality of additional ROs a subset of additional ROs that are activated, in the indicated set of additional ROs, for use by the UE; and transmitting a RACH transmission in at least one legacy RO of the plurality of legacy ROs or in at least one additional RO of the subset of additional ROs that is activated for use by the UE.

Another aspect provides a method for wireless communication by a network entity. The method includes transmitting first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs; transmitting second RACH configuration information configuring a plurality of additional ROs in one or more RACH configuration periods of the plurality of RACH configuration periods, wherein the second RACH configuration information defines the plurality of additional ROs relative to the plurality of legacy ROs; transmitting downlink control information (DCI) indicating: a set of additional ROs from the plurality of additional ROs a subset of additional ROs that are activated, in the indicated set of additional ROs, for use by the UE; and receiving a RACH transmission in at least one legacy RO of the plurality of legacy ROs or in at least one additional RO of the subset of additional ROs that is activated for use by the UE.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram illustrating an example four-step random access channel (RACH) procedure.

FIG. 6 depicts an example association of SSBs to RACH occasions (ROs).

FIG. 7 illustrates a timeline of a first random access channel (RACH) configuration.

FIG. 8 includes a diagram providing an illustration of RACH adaption involving adding ROs relative to a legacy RACH configuration.

FIG. 9 depicts a process flow including operations for communications in a network between a network entity and UE.

FIG. 10 includes a timeline illustrating a plurality of additional ROs configured by second RACH configuration information.

FIGS. 11A and 11B illustrate examples of implicit indication of a set of additional ROs.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure relate to wireless communications, and more particularly, to techniques for activating one or more subsets of additional random access channel (RACH) occasions.

As energy costs and environmental concerns grow, efficient network energy savings (NES) techniques are becoming increasingly important to conserve energy. In some cases, these NES techniques may involve adapting a number or periodicity of synchronization signal block (SSB) transmissions, as well as random access channel (RACH) occasions (ROs) for corresponding RACH transmissions, in a time domain. For example, a first random access channel (RACH) configuration may define a plurality of legacy ROs by specifying their time and frequency resources using a configuration index. To further optimize energy savings, a second RACH configuration may define one or more additional ROs relative to the legacy ROs, using a different periodicity or offset.

In some cases, to reduce energy consumption, the one or more additional ROs may be configured semi-statically through radio resource control (RRC) signaling and their availability for use by a user equipment (UE) may be dynamically signaled via downlink control information (DCI) messages. For example, instead of activating all ROs simultaneously, only a subset may be activated, conserving energy and reducing the need for a network entity to monitor any inactive ROs for RACH transmissions from the UE.

When a subset of additional random access opportunities (ROs) is activated, it is important to specify the set of additional ROs from which the subset is selected. This set may correspond to a specific time interval, such as a system frame or RACH configuration period, association period, or mapping cycle. Larger sets of additional ROs require a larger bit sequence (e.g., larger quantity of bits) to define the subset, particularly in dense configurations with many ROs. In contrast, sparse configurations with fewer ROs require a smaller bit sequence (e.g., smaller quantity of bits). As can be seen, the quantity of bits may vary significantly, and it is important that the UE know how to interpret the bit sequence to correctly determine the intended subset. If the UE misinterprets the bit sequence and attempts to use additional ROs that are not activated, this could lead to communication issues and inefficiencies.

Accordingly, aspects of the present disclosure provide techniques for efficiently defining and activating subsets of additional ROs. Additionally, aspects of the present disclosure provide techniques for enabling the UE to properly interpret the subset of additional ROs, ensuring that the UE can accurately determine which ROs are activated, thereby preventing potential communication issues and inefficiencies.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

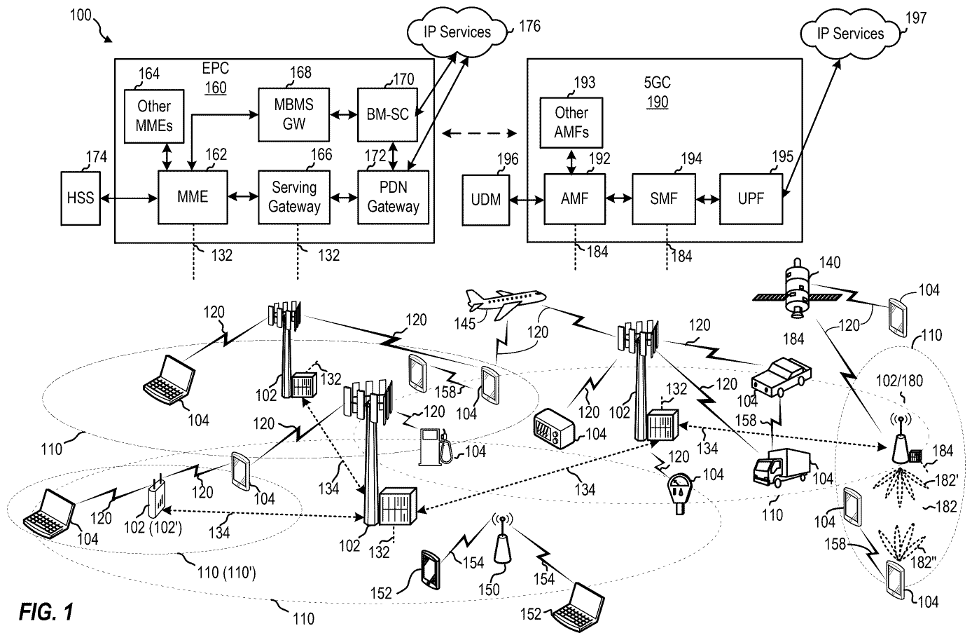

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

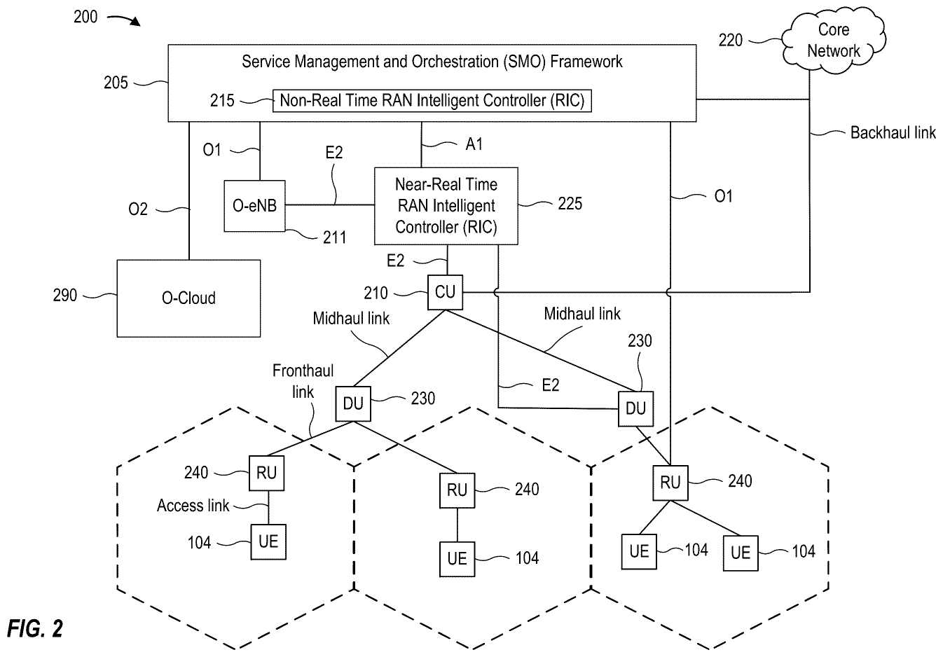

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

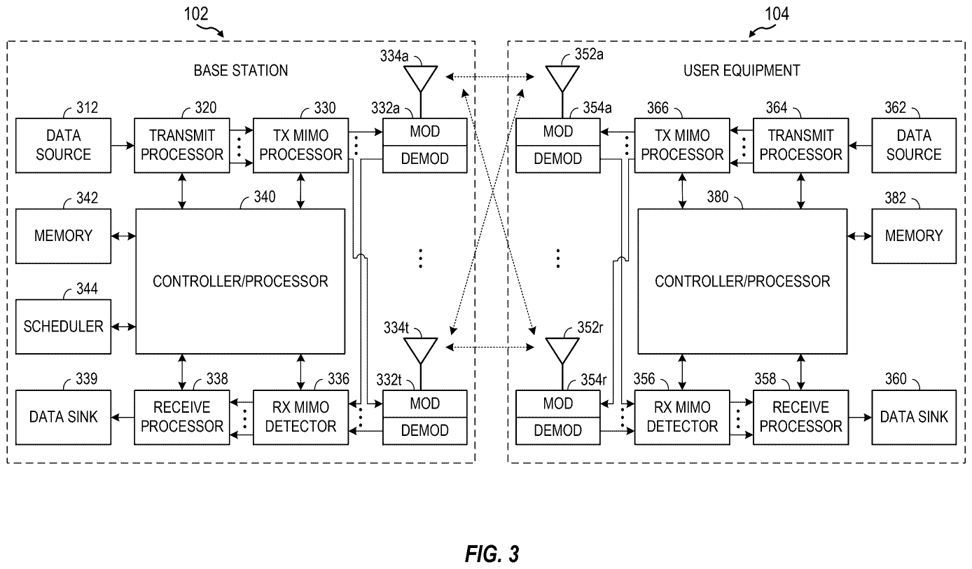

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

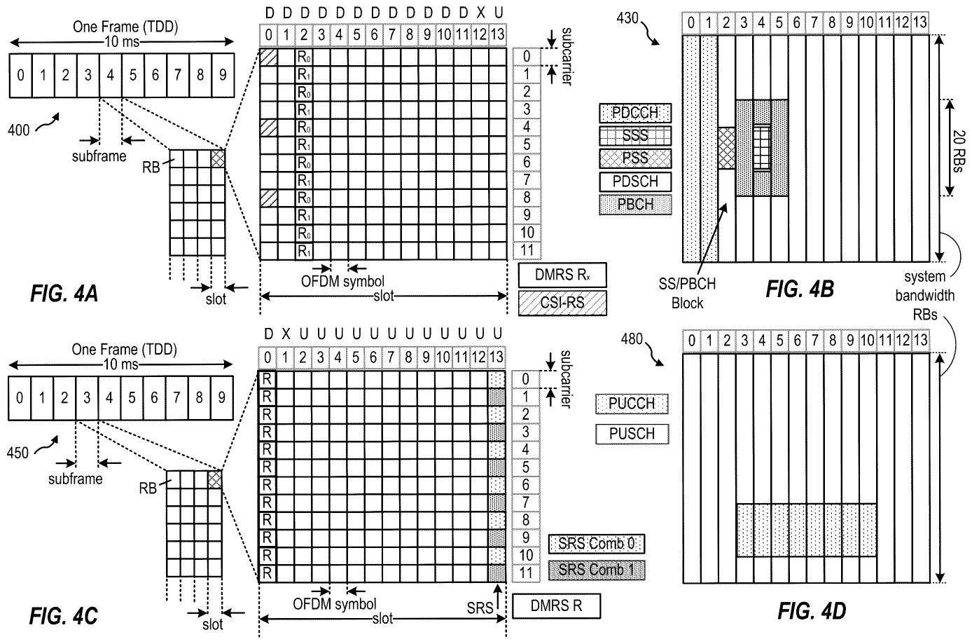

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Random Access Channel (RACH) Occasions (ROs)

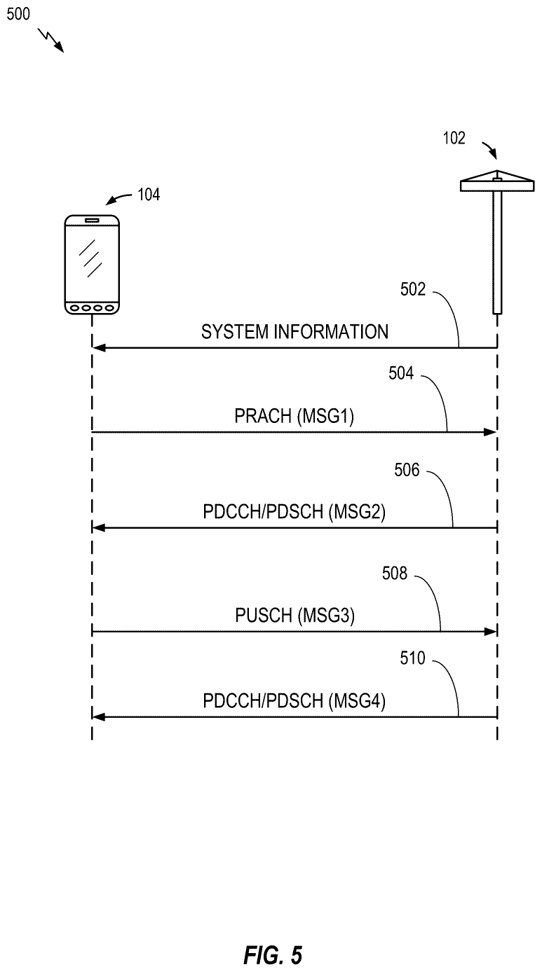

FIG. 5 is a call-flow diagram 500 illustrating an example four-step RACH procedure, in accordance with certain aspects of the present disclosure. A first message (MSG1) may be sent from the UE 104 to BS 102 on the physical random access channel (PRACH). In this case, MSG1 may only include a RACH preamble 504. BS 102 may respond with a random access response (RAR) message 506 (MSG2) which may include the identifier (ID) of the RACH preamble, a timing advance (TA), an uplink grant, cell radio network temporary identifier (C-RNTI), and a back off indicator (BI). MSG2 may include a PDCCH communication including control information for (e.g., scheduling a reception of) a following communication on the PDSCH, as illustrated. In response to MSG2, MSG3 is transmitted from the UE 104 to BS 102 on the PUSCH 508. MSG3 may include one or more of an RRC connection request, a tracking area update request, a system information request, a positioning fix or positioning signal request, or a scheduling request. The BS 102 then responds with MSG4 which may include a contention resolution message 510. In some cases, the UE 104 may also receive system information 502 (e.g., also referred to herein as a system information message) indicating various communication parameters that may be used by the UE 104 for communicating with the BS 102.

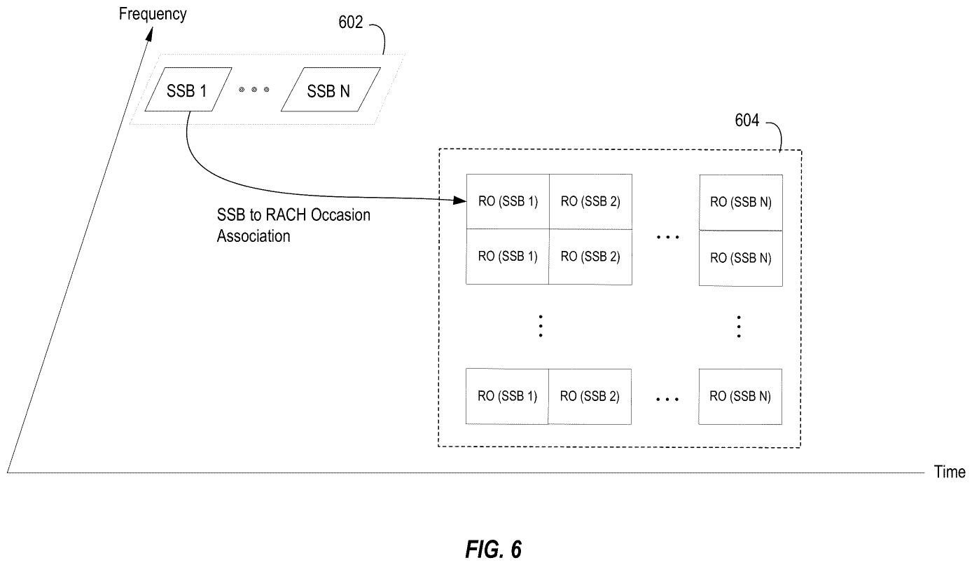

FIG. 6 depicts an example association (mapping) of SSBs 602 to RACH occasions (ROs) 604. This SSB to RO association is used for the gNB to know what beam the UE has acquired/is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

In some cases, SSBs/beams detected in one BWP may be mapped to ROs in another BWP. In such cases, aspects of the present disclosure may adjust PRACH related timing to account for BWP switching (e.g., extending a timeline in which the UE is expected to transmit a PRACH to account for additional BWP switching delay).

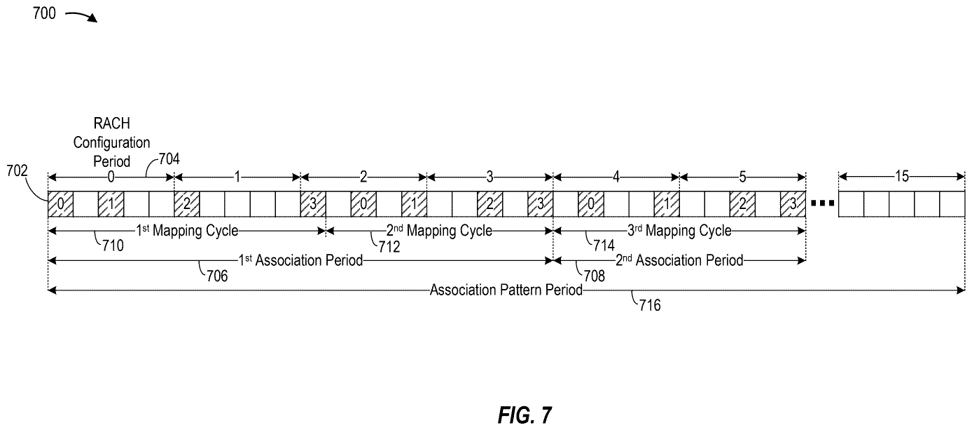

FIG. 7 illustrates a timeline 700 of a first RACH configuration including a plurality of ROs 702 configured within a 160 millisecond (ms) period of time, which may be used by a UE for transmitting one or more RACH transmissions (e.g., MSG1, etc. described above). As illustrated, the first RACH configuration defines various different time intervals in which the plurality of ROs may be transmitted. For example, as illustrated, the plurality of ROs 702 may be configured across a plurality of RACH configuration periods 704. In some embodiments, the plurality of RACH configuration periods 704 may be different lengths or periods depending on the first RACH configuration, such as 10 ms, 20 ms, 40 ms, 80 ms, or 160 ms. In the example shown in FIGS. 7, 16 RACH configuration periods 704 of 10 ms each may be configured by the first RACH configuration across the 160 ms period of time.

As shown in FIG. 7, each RO of the plurality of ROs 702 may be mapped to a particular SSB. For example, four different SSBs, labeled with index numbers 0, 1, 2, and 3, may be periodically mapped to different ROs across one or more RACH configuration periods 704. The time interval corresponding to one complete mapping of the SSBs to the different ROs may be referred to as an SSB-to-RO mapping cycle. It should be appreciated that first RACH configuration could include some ROs that are not mapped to any SSBs. In this case, these “unmapped” ROs may not be used by a UE for RACH transmissions).

Additionally, as shown in FIG. 7, the first RACH configuration includes a plurality of association periods, which may be defined in relation to the one or more RACH configuration periods 704 and an SSB-to-RO mapping cycle. For example, assuming a RACH configuration period of 10 ms, an association period may correspond to the smallest integer of {1, 2, 4, 8, or 16} RACH configuration periods across which all SSBs are mapped at least once. As shown, two association periods are depicted in FIG. 7: a first association period 706 and a second association period 708. It should be appreciated, however, that the first RACH configuration may configure more than two association periods within the 160 ms period of time.

The first association period 706 includes four RACH configuration periods (e.g., RACH configuration periods 0, 1, 2, and 3) and includes two SSB-to-RO mapping cycles: a first SSB-to-RO mapping cycle 710 and a second SSB-to-RO mapping cycle 712. As can be seen, since the first SSB-to-RO mapping cycle 710 is not completely contained within either one or two RACH configuration periods (e.g., RACH configuration periods 0 and 1) and instead extends into the third RACH configuration period (e.g., RACH configuration period 2), the first association period 706 may be defined to include the four RACH configuration periods. In contrast, the second association period 708 includes only two RACH configuration periods (e.g., 4 and 5) since a third SSB-to-RO mapping cycle 714 is fully contained within these two RACH configuration periods.

Further, as shown, the first RACH configuration may include an association pattern period 716, which may include a pattern of the association periods included within the 160 ms period of time, such as the first association period 706, the second association period 708, and any other association period configured by the first RACH configuration within the 160 ms period of time. The association pattern period 716 may be defined as the pattern of association periods over a period of 160 ms. In some cases, this pattern repeats every 160 ms, as the maximum RACH configuration periodicity is 160 ms.

### Aspects Related to Additional RACH Occasion Subset Activation

As energy cost and environmental impact become an increasing concern, various network energy savings (NES) techniques have been considered to reduce power consumption. Some such NES techniques involve adaptation of transmissions and/or receptions in time, frequency, spatial, or power domains. For example, in some cases, these NES techniques may involve adapting a number or periodicity of SSB transmissions, as well as ROs for corresponding RACH transmissions, in a time domain.

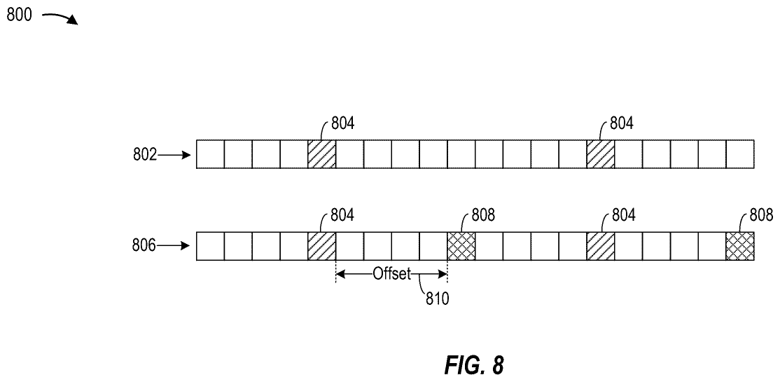

FIG. 8 includes a diagram 800 providing an illustration of RACH adaption involving adding ROs relative to a legacy RACH configuration. For example, as shown 802, the diagram 800 includes a first RACH configuration, including a plurality of legacy ROs 804. In some cases, the first RACH configuration may be associated with a configuration index that defines time and frequency resources for the plurality of legacy ROs 804. Further, as shown at 806, when RACH adaption is used, a second RACH configuration may configure one or more additional ROs, such as the additional ROs 808. In some cases, as shown, the additional ROs 808 may be defined relative to the plurality of legacy ROs 804. In some embodiments, the second RACH configuration may be associated with another configuration index, which may define the additional ROs 808 based on different periodicity or offset 810 relative to the plurality of legacy ROs 804.

Additional ROs may be configured semi-statically using radio resource control (RRC) signaling, with their availability dynamically signaled through a downlink control information (DCI) message. These techniques may promote efficient resource management while reducing unnecessary energy consumption. For example, instead of activating all configured ROs at once, only a subset may be activated, allowing a network entity to conserve energy by eliminating the need to monitor for RACH transmissions during any inactive additional ROs.

In some cases, when a subset of additional ROs are indicated to be activated, it may be important to indicate a set of additional ROs from which the subset of additional ROs is defined. For example, in some cases, the subset of additional ROs may include additional ROs that belong to or correspond to a particular time interval, such as a system frame or RACH configuration period, an association pattern period, an association period, an SSB-to-RO mapping cycle, a particular SSB, or another time interval. Each of these options may present trade-offs. However, in general, the larger the set of additional ROs, the larger the number of bits required to indicate the subset of additional ROs may be. For example, in a dense configuration, where the number of additional ROs in an association period or association pattern period is large, the number of bits required to indicate a subset of additional ROs may also be large. On the other hand, in a sparse configuration, where the number of ROs in the association period is small, the number of bits required to indicate the subset of additional ROs may be smaller. As can be seen, the number of bits can vary significantly, and it is important that the UE know how to interpret the bit sequence to correctly determine the intended subset. If the UE misinterprets the bit sequence and attempts to use additional ROs that are not activated, this could lead to communication issues and inefficiencies.

Accordingly, aspects of the present disclosure provide techniques for efficiently defining and activating subsets of additional ROs. Additionally, aspects of the present disclosure provide techniques for enabling the UE to properly interpret the subset of additional ROs, ensuring that the UE can accurately determine which ROs are activated, thereby preventing potential communication issues and inefficiencies.

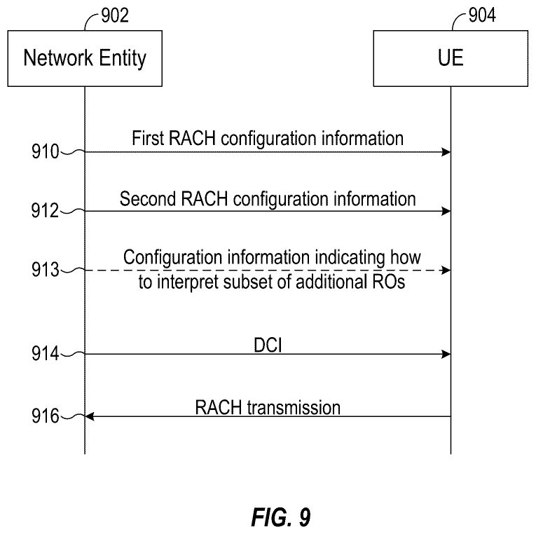

FIG. 9 depicts a process flow including operations 900 for communications in a network between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 904 may be another type of wireless communications device and network entity 902 may be another type of network entity or network node, such as those described herein.

As shown, operations 900 begin at 910 with the UE 904 receiving, from the network entity 902, first RACH configuration information configuring a plurality of RACH configuration periods and a plurality of legacy ROs (ROs). In some cases, each RACH configuration period of the plurality of RACH configuration periods may include at least one legacy RO of the plurality of legacy of ROs. For example, in some cases, the first RACH configuration information may include a RACH configuration index and may configure time and frequency resources for the plurality of legacy ROs within the plurality of RACH configuration periods.

As shown at 912, the UE 904 may receive, from the network entity 902, second RACH configuration information configuring a plurality of additional ROs in one or more RACH configuration periods of the plurality of RACH configuration periods. In some cases, the second RACH configuration information defines the plurality of additional ROs relative to the plurality of legacy ROs. For example, in some cases, the second configuration information may include an offset or a different periodicity that configures time and frequency resources for the plurality of additional ROs relative to the plurality of legacy ROs.

In some cases, the plurality of legacy ROs may be useable by legacy UEs and non-legacy UEs, including the UE 904. In some cases, the set of additional ROs may only usable by non-legacy UEs. In some cases, legacy UEs may comprise UEs configured to operate in compliance with, at most, Release 18 of a Third Generation Partnership Project (3GPP) wireless communication standard while non-legacy UEs comprise UEs configured to operate in compliance with, at least, a 3GPP wireless communication standard subsequent to Release 18.

As shown at 914, the UE 904 may receive, from the network entity 902, downlink control information (DCI). In some embodiments, the DCI may indicate a set of additional ROs from the plurality of additional ROs and a subset of additional ROs that are activated, in the indicated set of additional ROs, for use by the UE 904.

As shown at 916, the UE 904 may transmit a RACH transmission in at least one legacy RO of the plurality of legacy ROs or in at least one additional RO of the subset of additional ROs that is activated for use by the UE 904. In some embodiments, the RACH transmission may comprise a RACH preamble or sequence, for example, included in MSG1 of a RACH procedure for accessing the network entity 902.

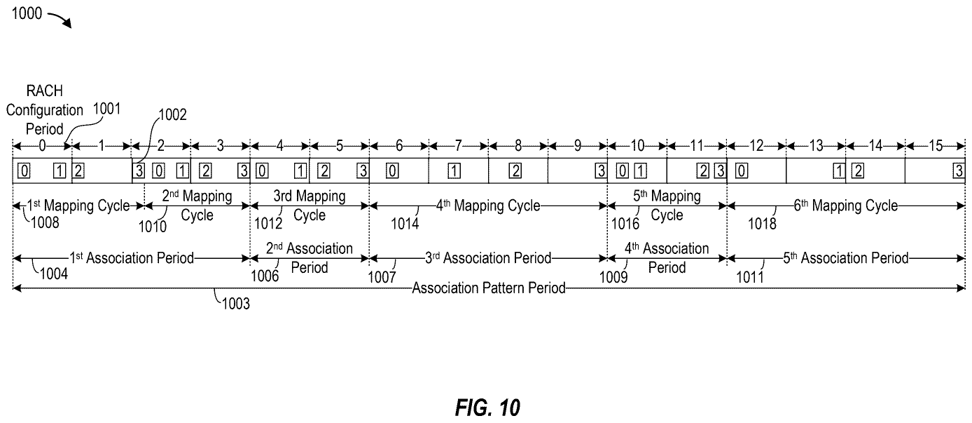

In some embodiments, the set of additional ROs indicated by the DCI may comprise a particular set of additional ROs corresponding to one or more particular time intervals, as shown in FIG. 10. For example, FIG. 10 illustrates a timeline 1000 that includes a plurality of RACH configuration periods 1001, which may be configured by the second RACH configuration within a 160 ms period of time. In some cases, each RACH configuration period within the plurality of RACH configuration periods 1001 may correspond to a system frame and have a duration of 10 ms, resulting in the configuration of 16 RACH configuration periods (e.g., labeled 0 through 15).

Further, as shown, each additional RO of the plurality of additional ROs 1002 may be included within one RACH configuration period of the plurality of RACH configuration periods 1001 and mapped to a particular SSB. For example, four different SSBs, labeled with index numbers 0, 1, 2, and 3, may be periodically mapped to different additional ROs across one or more RACH configuration periods 1001. Further, as illustrated, the one or more RACH configuration periods 1001 include 16 different RACH configuration periods, each having a period of 10 ms

Accordingly, in some embodiments, the particular set of additional ROs may comprise a first set of additional ROs including, but limited to, all additional ROs corresponding to a system frame or RACH configuration period, such as RACH configuration period #0 of the plurality of RACH configuration periods 1001. In some embodiments, the particular set of ROs may comprise a second set of additional ROs including, but limited to, all additional ROs corresponding to a RACH association pattern period, such as the additional ROs 1002 included within an association pattern period 1003. In some embodiments, an ending association pattern period 1003 may align with an ending of a system frame, as shown in FIG. 10, but in other embodiments, the association pattern period 1003 may be shorter or longer than a system frame.

In some embodiments, the particular set of ROs may comprise a third set of additional ROs including, but limited to, all additional ROs corresponding to a RACH association period, such as the additional ROs 1002 included within a first association period 1004, a second association period 1006, a third association period 1007, a fourth association period 1009, or a fifth association period 1011, for example, included within the association pattern period 1003.

In some embodiments, the particular set of ROs may comprise a fourth set of additional ROs including, but limited to, all additional ROs corresponding to a SSB-to-RO mapping cycle, such as the additional ROs 1002 included within a first SSB-to-RO mapping cycle 1008, a second SSB-to-RO mapping cycle 1010, a third SSB-to-RO mapping cycle 1012, a fourth SSB-to-RO mapping cycle 1014, a fifth SSB-to-RO mapping cycle 1016, or a sixth SSB-to-RO mapping cycle 1018. In some cases, the particular set of ROs may comprise a fifth set of additional ROs corresponding to, but limited to, all additional ROs mapped to a particular SSB, such as the additional ROs 1002 mapped to SSB index number 2.

In some embodiments, the DCI may include a first set of bits that indicate the subset of additional ROs that are activated for use by the UE 904. In some embodiments, a quantity of the first set of bits that indicate the subset of additional ROs that are activated for use by the UE 904 may implicitly indicate which particular set of additional ROs that the indicated set of additional ROs is. For example, in some cases, when the quantity of bits of the first set of bits is greater than or equal to a quantity of additional ROs in the first set of additional ROs, the quantity of bits of the first set of bits implicitly indicates that the set of additional ROs is the first set of additional ROs. In some cases, when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs. In some cases, when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs. In some cases, when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs. In some cases, when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

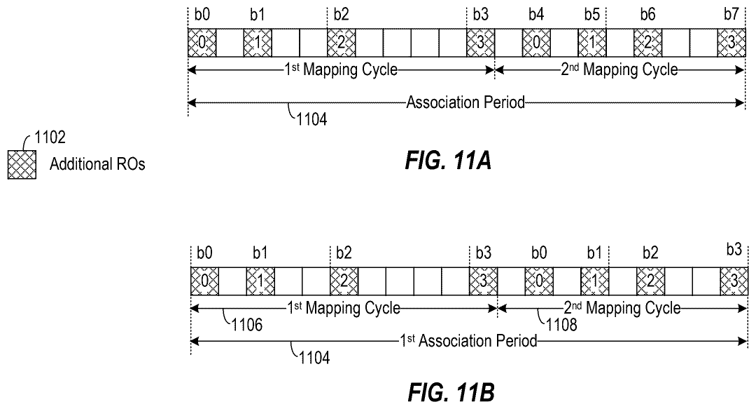

FIGS. 11A and 11B provide two examples of implicit indication of which particular set of additional ROs that the indicated set of additional ROs is, according to certain aspects.

FIG. 11A provides a first example in which the first set of bits used to indicate the subset of additional ROs includes a quantity of 8 bits (e.g., bits b0 through b7). As shown, each different bit of the first set of bits may correspond to a different additional RO 1102, with a quantity of bits being sufficient to represent all additional ROs within the association period 1104. Accordingly, in this case, because there are a sufficient amount of bits to represent all additional ROs within the association period 1104, the quantity of bits may implicitly indicate that the indicated set of additional ROs comprises the third set of additional ROs including, but limited to, all additional ROs corresponding to the association period 1104.

FIG. 11B provides a second example in which the first set of bits used to indicate the subset of additional ROs includes a quantity of 4 bits (e.g., bits b0 through b3). In contrast to FIG. 11A, the quantity of bits in FIG. 11B may not be sufficient to represent all additional ROs within the association period 1104. Instead, the quantity of bits may only be sufficient to represent the additional ROs within, for example, the first SSB-to-RO mapping cycle 1106 or the second SSB-to-RO mapping cycle 1108. Accordingly, in this case, the quantity of bits may implicitly indicate that the indicated set of additional ROs comprises the third set of additional ROs including, but limited to, all additional ROs corresponding to the first SSB-to-RO mapping cycle 1106 or the second SSB-to-RO mapping cycle 1108.

In some embodiments, the UE 904 may receive a second set of bits that explicitly indicates which particular set of ROs that the indicated set of additional ROs is. In some cases, the second set of bits may dynamically or semi-statically configure which particular set of ROs that the indicated set of additional ROs is. In some embodiments, the second set of bits may be included in the DCI, RRC signaling, a media access control-control element (MAC-CE), or another type of control message.

In some cases, different combinations of the second set of bits may correspond to different sets of additional ROs. For example, a first combination of the second set of bits may indicate that the set of additional ROs comprises the first set of additional ROs including, but limited to, all additional ROs corresponding to a system frame or RACH configuration period. In some cases, a second combination of the second set of bits may indicate that the set of additional ROs comprises the second set of additional ROs including, but limited to, all additional ROs corresponding to a RACH association pattern period. In some cases, a third combination of the second set of bits may indicate that the set of additional ROs comprises the third set of additional ROs including, but limited to, all additional ROs corresponding to an association period. In some cases, a fourth combination of the second set of bits may indicate that the set of additional ROs comprises the fourth set of additional ROs including, but limited to, all additional ROs corresponding to a SSB-to-RO mapping cycle. In some cases, a fourth combination of the second set of bits may indicate that the set of additional ROs comprises the fifth set of additional ROs corresponding to, but limited to, all additional ROs mapped to a particular SSB.

In some embodiments, a number of ROs in a given time interval may vary. For example, in some cases, the size or length of association periods may differ, with each association period containing a different number of ROs. Accordingly, because both the size of the time interval and the number of additional ROs within that time interval may vary, the quantity of the first set of bits that indicate the subset of additional ROs may also vary between time intervals. To ensure proper interpretation, the UE 904 may need to know the quantity of the first set of bits that indicate the subset of additional ROs for each time interval. Otherwise, misinterpretation or incorrect mapping of the additional ROs may occur. Accordingly, to help ensure that the UE 904 properly interprets the subset of additional ROs indicated in the DCI, in some embodiments, the quantity of the first set of bits may be semi-statically configured or dynamically indicated in the DCI. In some cases, the quantity of the first set of bits may be indicated based on a function of a maximum number of additional ROs across all of the one or more particular time intervals. For example, the quantity of the first set of bits may be equal to the maximum number of ROs across all association periods.

In some embodiments, the subset of additional ROs may be indicated in various manners. For example, in some embodiments, the first set of bits that indicate the subset of additional ROs may include a bitmap comprising one or more bits. In some cases, each different bit of the one or more bits of the bitmap may correspond to a different additional RO in the set of additional ROs and indicates that that different additional RO is activated for use by the UE. For example, with reference to FIG. 11B, in some cases, the bitmap may include four bits (e.g., bits b0 through b3) and each bit may correspond to one of the additional ROs within the first SSB-to-RO mapping cycle 1106. For example, a bitmap of 0110 (e.g., b0=0, b1=1, b2=1, and b3=0) may indicate that the additional RO corresponding to bit b0 (e.g., the additional RO mapped to SSB index number 0) is inactive, that the additional RO corresponding to bit b1 (e.g., the additional RO mapped to SSB index number 1) is active, the additional RO corresponding to bit b2 (e.g., the additional RO mapped to SSB index number 2) is active, and that the additional RO corresponding to bit b3 (e.g., the additional RO mapped to SSB index number 3) is inactive. While in the preceding example a bit value of 0 may indicate that an additional RO is inactive and a bit value of 1 may indicate that an additional RO is active, it should be appreciated that an opposite configuration may be used. For example, in some embodiments, a bit value of 0 may indicate that an additional RO is active and a bit value of 1 may indicate that an additional RO is inactive.

In some embodiments, the first set of bits that indicate the subset of additional ROs may have an interpretation that may be semi-statically indicated or fixed within a wireless communications standard. For example, in some embodiments, as shown at 913 in FIG. 9, the UE 904 may optionally receive additional configuration information indicating how to interpret different combinations of the first set of bits to determine which additional ROs, from the set of additional ROs, are included in the subset of ROs. In some cases, the additional configuration information may be semi-statically configured or fixed in a wireless communication standard.

As an example, in some cases, the additional configuration information may indicate that, for a first combination of the first set of bits (e.g., 00), all additional ROs of the set of additional ROs are included in the subset of additional ROs and are activated for use by the UE 904. In some cases, the additional configuration information may indicate that, for a second combination of the first set of bits (e.g., 01), only additional ROs from the set of additional ROs that are included in even numbered RACH configuration periods of the plurality of RACH configuration periods are included in the subset of additional ROs and are activated for use by the UE. For example, with reference to FIG. 10, the second combination of the first set of bits may indicate that only the additional ROs in RACH configuration periods 0 and 2 of the first association period 1004 are included in the subset of additional ROs and activated for use by the UE 904. In some cases, the additional configuration information may indicate that, for a third combination of the first set of bits (e.g., 10), only additional ROs from the set of additional ROs that are included in odd numbered RACH configuration periods of the plurality of RACH configuration periods are included in the subset of additional ROs and are activated for use by the UE. For example, with reference to FIG. 10, the third combination of the first set of bits may indicate that only the additional ROs in RACH configuration periods 1 and 3 of the first association period 1004 are included in the subset of additional ROs and activated for use by the UE 904.

In some embodiments, the first set of bits may include a first sequence of bits (e.g., seq1) and a second sequence of bits (e.g., seq2) and the additional configuration information may indicate to apply the first sequence of bits and the second sequence of bits to different time intervals. For example, the additional configuration information may configure the UE 904 to apply the first sequence of bits to particular time intervals of the one or more particular time intervals having a length greater than or equal to a threshold length and to apply the second sequence of bits applies to particular time intervals of the one or more particular time intervals having a length less than the threshold length. As an example, the additional configuration information may configure the UE 904 to apply the first sequence of bits to time intervals having less than four RACH configuration periods and to apply the second sequence of bits to time intervals having greater than or equal to four RACH configuration periods. In some cases, the first sequence of bits may indicate the subset of additional ROs that are activated for use by the UE 904 in the particular time intervals having the length greater than or equal to the threshold length. Additionally, the second sequence of bits indicates the subset of additional ROs that are activated for use by the UE 904 in the particular time intervals having the length less than the threshold length

Accordingly, for example, with reference to FIG. 10, the additional configuration information may configure the UE 904 to apply the first sequence of bits to the second association period 1006 (e.g., having two RACH configuration periods) and to apply the second sequence of bits to the first association period 1004 (e.g., having four RACH configuration periods). In this case, the first sequence of bits may indicate the subset of additional ROs that are activated for use by the UE 904 in the second association period 1006 while the second sequence of bits may indicate the subset of additional ROs that are activated for use by the UE 904 in the first association period 1004. Further, with reference to the techniques described above regarding the different combinations of the first set of bits, assume that the first set of bits has a bit sequence of 0110 such that the first sequence of bits is equal to 01 (e.g., even RACH configuration periods) and the second sequence of bits is equal to 10 (e.g., odd RACH configuration periods). In this scenario, the additional configuration information may configure the UE 904 to include only additional ROs from RACH configuration period 4 in the subset of additional ROs for the second association period 1006. Additionally, in this scenario, the additional configuration information may configure the UE 904 to include only additional ROs from RACH configuration periods 1 and 3 in the subset of additional ROs for the first association period 1004.

In some embodiments, the additional configuration information may configure the UE 904 to apply the first sequence of bits to even numbered time intervals of the one or more particular time intervals and to apply the second sequence of bits applies to odd numbered time intervals of the one or more particular time intervals. In this scenario, the first sequence of bits may indicate the subset of additional ROs that are activated for use by the UE in the even numbered time intervals of the one or more particular time intervals. Additionally, the second sequence of bits indicates the subset of additional ROs that are activated for use by the UE in the odd numbered time intervals of the one or more particular time intervals.

Accordingly, for example, with reference to FIG. 10, the additional configuration information may configure the UE 904 to apply the first sequence of bits to the second association period 1006 and to apply the second sequence of bits to the first association period 1004. In this scenario, the first sequence of bits may indicate which additional ROs from the second association period 1006 are included in the subset of additional ROs and are activated for use by the UE 904. Similarly, the second sequence of bits may indicate which additional ROs from the first association period 1004 are included in the subset of additional ROs and are activated for use by the UE 904.

### Example Operations

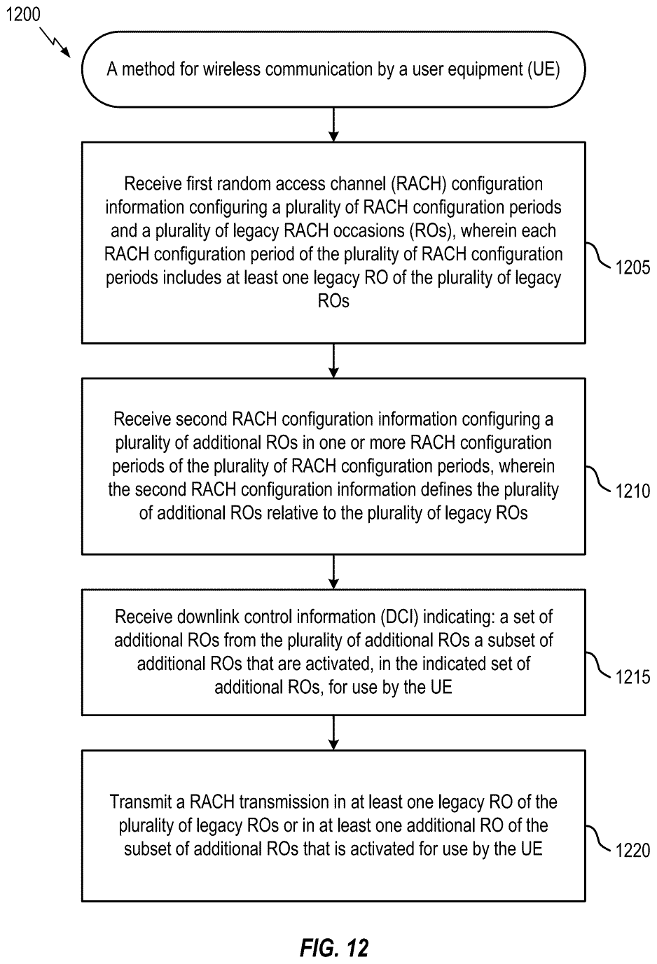

FIG. 12 shows an example of a method 1200 of wireless communication by a user equipment (UE), such as a UE 104 of FIGS. 1 and 3.

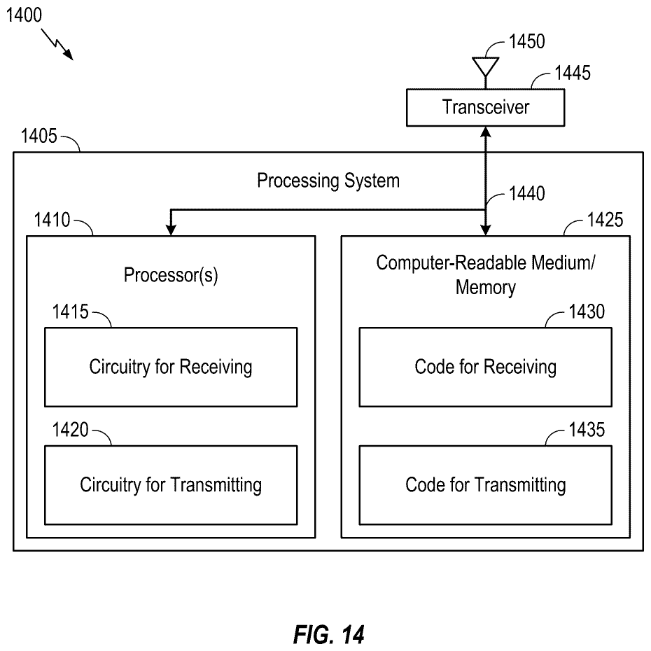

Method 1200 begins at step 1205 with receiving first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs. In some cases, the operations of this step refer to, or may be performed by, circuitry for receiving and/or code for receiving as described with reference to FIG. 14.

Method 1200 then proceeds to step 1210 with receiving second RACH configuration information configuring a plurality of additional ROs in one or more RACH configuration periods of the plurality of RACH configuration periods, wherein the second RACH configuration information defines the plurality of additional ROs relative to the plurality of legacy ROs. In some cases, the operations of this step refer to, or may be performed by, circuitry for receiving and/or code for receiving as described with reference to FIG. 14.

Method 1200 then proceeds to step 1215 with receiving downlink control information (DCI) indicating: a set of additional ROs from the plurality of additional ROs a subset of additional ROs that are activated, in the indicated set of additional ROs, for use by the UE. In some cases, the operations of this step refer to, or may be performed by, circuitry for receiving and/or code for receiving as described with reference to FIG. 14.

Method 1200 then proceeds to step 1220 with transmitting a RACH transmission in at least one legacy RO of the plurality of legacy ROs or in at least one additional RO of the subset of additional ROs that is activated for use by the UE. In some cases, the operations of this step refer to, or may be performed by, circuitry for transmitting and/or code for transmitting as described with reference to FIG. 14.

In some aspects, the set of additional ROs comprises a particular set of additional ROs corresponding to one or more particular time intervals; and the particular set of additional ROs comprises one of: a first set of additional ROs including all additional ROs corresponding to a system frame or RACH configuration period; a second set of additional ROs including all additional ROs corresponding to a RACH association pattern period; a third set of additional ROs including all additional ROs corresponding to a RACH association period; a fourth set of additional ROs including all additional ROs corresponding to a synchronization signal block (SSB)-to-RO mapping cycle; or a fifth set of additional ROs corresponding to all additional ROs mapped to a particular synchronization signal block (SSB).

In some aspects, the DCI includes a first set of bits that indicate the subset of additional ROs that are activated for use by the UE.

In some aspects, a quantity of the first set of bits is one of: semi-statically configured; dynamically indicated in the DCI; or indicated based on a function of a maximum number of additional ROs across all of the one or more particular time intervals.

In some aspects, a quantity of the first set of bits that indicate the subset of additional ROs that are activated for use by the UE implicitly indicates which particular set of additional ROs that the indicated set of additional ROs is.

In some aspects, when the quantity of bits of the first set of bits is greater than or equal to a quantity of additional ROs in the first set of additional ROs, the quantity of bits of the first set of bits implicitly indicates that the set of additional ROs is the first set of additional ROs; when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs; and when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs; when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs; and when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

In some aspects, the method 1200 further includes receiving a second set of bits that explicitly indicates which particular set of ROs that the indicated set of additional ROs is. In some cases, the operations of this step refer to, or may be performed by, circuitry for receiving and/or code for receiving as described with reference to FIG. 14.

In some aspects, the second set of bits dynamically or semi-statically configures the set of additional ROs.

In some aspects, receiving the second set of bits comprises receiving the second set of bits in at least one of: the DCI; a radio resource control (RRC) message; or a media access control-control element (MAC-CE) message.

In some aspects, the first set of bits that indicate the subset of additional ROs includes a bitmap comprising one or more bits; and each different bit of the one or more bits of the bitmap corresponds to a different additional RO in the set of additional ROs and indicates that that different additional RO is activated for use by the UE.

In some aspects, the method 1200 further includes receiving additional configuration information indicating how to interpret different combinations of the first set of bits to determine which additional ROs, from the set of additional ROs, are included in the subset of ROs. In some cases, the operations of this step refer to, or may be performed by, circuitry for receiving and/or code for receiving as described with reference to FIG. 14.

In some aspects, the additional configuration information is semi-statically configured or fixed in a wireless communication standard.

In some aspects, the additional configuration information indicates, at least one of, that: for a first combination, all additional ROs of the set of additional ROs are included in the subset of additional ROs and are activated for use by the UE; for a second combination, only additional ROs from the set of additional ROs that are included in even numbered RACH configuration periods of the plurality of RACH configuration periods are included in the subset of additional ROs and are activated for use by the UE; or for a third combination, only additional ROs from the set of additional ROs that are included in odd numbered RACH configuration periods of the plurality of RACH configuration periods are included in the subset of additional ROs and are activated for use by the UE.

In some aspects, the first set of bits includes a first sequence of bits and a second sequence of bits.

In some aspects, the first sequence of bits and second sequence of bits apply to different particular time intervals of the one or more particular time intervals depending on lengths of the different particular time intervals.

In some aspects, the first sequence of bits applies to particular time intervals of the one or more particular time intervals having a length greater than or equal to a threshold length; and the second sequence of bits applies to particular time intervals of the one or more particular time intervals having a length less than the threshold length.

In some aspects, the first sequence of bits indicates the subset of additional ROs that are activated for use by the UE in the particular time intervals having the length greater than or equal to the threshold length; and the second sequence of bits indicates the subset of additional ROs that are activated for use by the UE in the particular time intervals having the length less than the threshold length.

In some aspects, the first sequence of bits applies to even numbered time intervals of the one or more particular time intervals; and the second sequence of bits applies to odd numbered time intervals of the one or more particular time intervals.

In some aspects, the first sequence of bits indicates the subset of additional ROs that are activated for use by the UE in the even numbered time intervals of the one or more particular time intervals; and the second sequence of bits indicates the subset of additional ROs that are activated for use by the UE in the odd numbered time intervals of the one or more particular time intervals.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

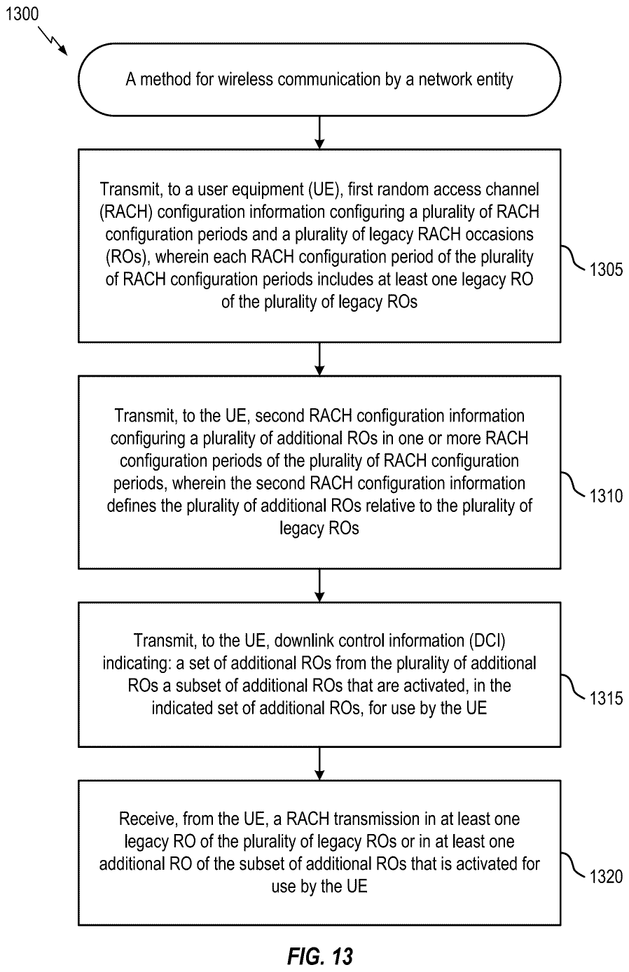

FIG. 13 shows an example of a method 1300 of wireless communication by a network entity, such as a BS 102 of FIGS. 1 and 3, or a disaggregated base station as discussed with respect to FIG. 2.

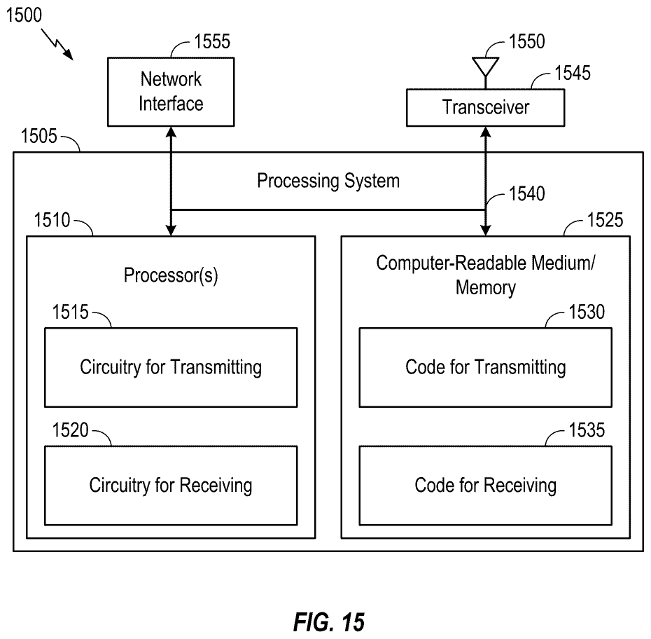

Method 1300 begins at step 1305 with transmitting, to a user equipment (UE), first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs. In some cases, the operations of this step refer to, or may be performed by, circuitry for transmitting and/or code for transmitting as described with reference to FIG. 15.

Method 1300 then proceeds to step 1310 with transmitting, to the UE, second RACH configuration information configuring a plurality of additional ROs in one or more RACH configuration periods of the plurality of RACH configuration periods, wherein the second RACH configuration information defines the plurality of additional ROs relative to the plurality of legacy ROs. In some cases, the operations of this step refer to, or may be performed by, circuitry for transmitting and/or code for transmitting as described with reference to FIG. 15.

Method 1300 then proceeds to step 1315 with transmitting, to the UE, downlink control information (DCI) indicating: a set of additional ROs from the plurality of additional ROs a subset of additional ROs that are activated, in the indicated set of additional ROs, for use by the UE. In some cases, the operations of this step refer to, or may be performed by, circuitry for transmitting and/or code for transmitting as described with reference to FIG. 15.

Method 1300 then proceeds to step 1320 with receiving, from the UE, a RACH transmission in at least one legacy RO of the plurality of legacy ROs or in at least one additional RO of the subset of additional ROs that is activated for use by the UE. In some cases, the operations of this step refer to, or may be performed by, circuitry for receiving and/or code for receiving as described with reference to FIG. 15.

In some aspects, the set of additional ROs comprises a particular set of additional ROs corresponding to one or more particular time intervals; and the particular set of additional ROs comprises one of: a first set of additional ROs including all additional ROs corresponding to a system frame or RACH configuration period; a second set of additional ROs including all additional ROs corresponding to a RACH association pattern period; a third set of additional ROs including all additional ROs corresponding to a RACH association period; a fourth set of additional ROs including all additional ROs corresponding to a synchronization signal block (SSB)-to-RO mapping cycle; or a fifth set of additional ROs corresponding to all additional ROs mapped to a particular synchronization signal block (SSB).

In some aspects, the DCI includes a first set of bits that indicate the subset of additional ROs that are activated for use by the UE.

In some aspects, a quantity of the first set of bits is one of: semi-statically configured; dynamically indicated in the DCI; or indicated based on a function of a maximum number of additional ROs across all of the one or more particular time intervals.

In some aspects, a quantity of the first set of bits that indicate the subset of additional ROs that are activated for use by the UE implicitly indicates which particular set of additional ROs that the indicated set of additional ROs is.

In some aspects, when the quantity of bits of the first set of bits is greater than or equal to a quantity of additional ROs in the first set of additional ROs, the quantity of bits of the first set of bits implicitly indicates that the set of additional ROs is the first set of additional ROs; when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs; and when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs; when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs; and when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

In some aspects, the method 1300 further includes transmitting a second set of bits that explicitly indicates which particular set of ROs that the indicated set of additional ROs is. In some cases, the operations of this step refer to, or may be performed by, circuitry for transmitting and/or code for transmitting as described with reference to FIG. 15.

In some aspects, the second set of bits dynamically or semi-statically configures the set of additional ROs.

In some aspects, transmitting the second set of bits comprises transmitting the second set of bits in at least one of: the DCI; a radio resource control (RRC) message; or a media access control-control element (MAC-CE) message.

In some aspects, the first set of bits that indicate the subset of additional ROs includes a bitmap comprising one or more bits; and each different bit of the one or more bits of the bitmap corresponds to a different additional RO in the set of additional ROs and indicates that that different additional RO is activated for use by the UE.

In some aspects, the method 1300 further includes receiving additional configuration information indicating how to interpret different combinations of the first set of bits to determine which additional ROs, from the set of additional ROs, are included in the subset of ROs. In some cases, the operations of this step refer to, or may be performed by, circuitry for receiving and/or code for receiving as described with reference to FIG. 15.

In some aspects, the additional configuration information is semi-statically configured or fixed in a wireless communication standard.

In some aspects, the additional configuration information indicates, at least one of, that: for a first combination, all additional ROs of the set of additional ROs are included in the subset of additional ROs and are activated for use by the UE; for a second combination, only additional ROs from the set of additional ROs that are included in even numbered RACH configuration periods of the plurality of RACH configuration periods are included in the subset of additional ROs and are activated for use by the UE; or for a third combination, only additional ROs from the set of additional ROs that are included in odd numbered RACH configuration periods of the plurality of RACH configuration periods are included in the subset of additional ROs and are activated for use by the UE.

In some aspects, the first set of bits includes a first sequence of bits and a second sequence of bits.

In some aspects, the first sequence of bits and second sequence of bits apply to different particular time intervals of the one or more particular time intervals depending on lengths of the different particular time intervals.

In some aspects, the first sequence of bits applies to particular time intervals of the one or more particular time intervals having a length greater than or equal to a threshold length; and the second sequence of bits applies to particular time intervals of the one or more particular time intervals having a length less than the threshold length.

In some aspects, the first sequence of bits indicates the subset of additional ROs that are activated for use by the UE in the particular time intervals having the length greater than or equal to the threshold length; and the second sequence of bits indicates the subset of additional ROs that are activated for use by the UE in the particular time intervals having the length less than the threshold length.

In some aspects, the first sequence of bits applies to even numbered time intervals of the one or more particular time intervals; and the second sequence of bits applies to odd numbered time intervals of the one or more particular time intervals.

In some aspects, the first sequence of bits indicates the subset of additional ROs that are activated for use by the UE in the even numbered time intervals of the one or more particular time intervals; and the second sequence of bits indicates the subset of additional ROs that are activated for use by the UE in the odd numbered time intervals of the one or more particular time intervals.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Device(s)

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1445 (e.g., a transmitter and/or a receiver). The transceiver 1445 is configured to transmit and receive signals for the communications device 1400 via the antenna 1450, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1425 stores code (e.g., executable instructions), such as code for receiving 1430 and code for transmitting 1435. Processing of the code for receiving 1430 and code for transmitting 1435 may cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry such as circuitry for receiving 1415 and circuitry for transmitting 1420. Processing with circuitry for receiving 1415 and circuitry for transmitting 1420 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1445 and the antenna 1450 of the communications device 1400 in FIG. 14. Means for receiving or obtaining may include transceivers 354 and/or antenna(s) 352 of the UE 104 illustrated in FIG. 3 and/or the transceiver 1445 and the antenna 1450 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1545 (e.g., a transmitter and/or a receiver) and/or a network interface 1555. The transceiver 1545 is configured to transmit and receive signals for the communications device 1500 via the antenna 1550, such as the various signals as described herein. The network interface 1555 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1525 stores code (e.g., executable instructions), such as code for transmitting 1530 and code for receiving 1535. Processing of the code for transmitting 1530 and code for receiving 1535 may cause the communications device 1500 to perform the method 1300 described with respect to FIG. 13, or any aspect related to it.

The one or more processors 1510 include circuitry configured to implement (e.g., execute) the code stored in the computer-readable medium/memory 1525, including circuitry such as circuitry for transmitting 1515 and circuitry for receiving 1520. Processing with circuitry for transmitting 1515 and circuitry for receiving 1520 may cause the communications device 1500 to perform the method 1300 described with respect to FIG. 13, or any aspect related to it.

Various components of the communications device 1500 may provide means for performing the method 1300 described with respect to FIG. 13, or any aspect related to it. Means for transmitting, sending or outputting for transmission may include transceivers 332 and/or antenna(s) 334 of the BS 102 illustrated in FIG. 3 and/or the transceiver 1545 and the antenna 1550 of the communications device 1500 in FIG. 15. Means for receiving or obtaining may include transceivers 332 and/or antenna(s) 334 of the BS 102 illustrated in FIG. 3 and/or the transceiver 1545 and the antenna 1550 of the communications device 1500 in FIG. 15.

### Example Clauses

Implementation examples are described in the following numbered clauses:

Clause 1: A method for wireless communication by a user equipment (UE), comprising: receiving first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs; receiving second RACH configuration information configuring a plurality of additional ROs in one or more RACH configuration periods of the plurality of RACH configuration periods, wherein the second RACH configuration information defines the plurality of additional ROs relative to the plurality of legacy ROs; receiving downlink control information (DCI) indicating: a set of additional ROs from the plurality of additional ROs a subset of additional ROs that are activated, in the indicated set of additional ROs, for use by the UE; and transmitting a RACH transmission in at least one legacy RO of the plurality of legacy ROs or in at least one additional RO of the subset of additional ROs that is activated for use by the UE.

Clause 2: The method of Clause 1, wherein: the set of additional ROs comprises a particular set of additional ROs corresponding to one or more particular time intervals; and the particular set of additional ROs comprises one of: a first set of additional ROs including all additional ROs corresponding to a system frame or RACH configuration period; a second set of additional ROs including all additional ROs corresponding to a RACH association pattern period; a third set of additional ROs including all additional ROs corresponding to a RACH association period; a fourth set of additional ROs including all additional ROs corresponding to a synchronization signal block (SSB)-to-RO mapping cycle; or a fifth set of additional ROs corresponding to all additional ROs mapped to a particular synchronization signal block (SSB).

Clause 3: The method of Clause 2, wherein the DCI includes a first set of bits that indicate the subset of additional ROs that are activated for use by the UE.

Clause 4: The method of Clause 3, wherein a quantity of the first set of bits is one of: semi-statically configured; dynamically indicated in the DCI; or indicated based on a function of a maximum number of additional ROs across all of the one or more particular time intervals.

Clause 5: The method of Clause 3, wherein a quantity of the first set of bits that indicate the subset of additional ROs that are activated for use by the UE implicitly indicates which particular set of additional ROs that the indicated set of additional ROs is.

Clause 6: The method of Clause 5, wherein: when the quantity of bits of the first set of bits is greater than or equal to a quantity of additional ROs in the first set of additional ROs, the quantity of bits of the first set of bits implicitly indicates that the set of additional ROs is the first set of additional ROs; when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs; and when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs; when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs; and when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

Clause 7: The method of Clause 3, further comprising receiving a second set of bits that explicitly indicates which particular set of ROs that the indicated set of additional ROs is.

Clause 8: The method of Clause 7, wherein the second set of bits dynamically or semi-statically configures the set of additional ROs.

Clause 9: The method of Clause 8, wherein receiving the second set of bits comprises receiving the second set of bits in at least one of: the DCI; a radio resource control (RRC) message; or a media access control-control element (MAC-CE) message.

Clause 10: The method of Clause 3, wherein: the first set of bits that indicate the subset of additional ROs includes a bitmap comprising one or more bits; and each different bit of the one or more bits of the bitmap corresponds to a different additional RO in the set of additional ROs and indicates that that different additional RO is activated for use by the UE.

Clause 11: The method of Clause 3, further comprising receiving additional configuration information indicating how to interpret different combinations of the first set of bits to determine which additional ROs, from the set of additional ROs, are included in the subset of ROs.

Clause 12: The method of Clause 11, wherein the additional configuration information is semi-statically configured or fixed in a wireless communication standard.

Clause 13: The method of Clause 11, wherein the additional configuration information indicates, at least one of, that: for a first combination, all additional ROs of the set of additional ROs are included in the subset of additional ROs and are activated for use by the UE; for a second combination, only additional ROs from the set of additional ROs that are included in even numbered RACH configuration periods of the plurality of RACH configuration periods are included in the subset of additional ROs and are activated for use by the UE; or for a third combination, only additional ROs from the set of additional ROs that are included in odd numbered RACH configuration periods of the plurality of RACH configuration periods are included in the subset of additional ROs and are activated for use by the UE.

Clause 14: The method of Clause 3, wherein the first set of bits includes a first sequence of bits and a second sequence of bits.
Clause 15: The method of Clause 14, wherein the first sequence of bits and second sequence of bits apply to different particular time intervals of the one or more particular time intervals depending on lengths of the different particular time intervals.

Clause 16: The method of Clause 15, wherein: the first sequence of bits applies to particular time intervals of the one or more particular time intervals having a length greater than or equal to a threshold length; and the second sequence of bits applies to particular time intervals of the one or more particular time intervals having a length less than the threshold length.

Clause 17: The method of Clause 16, wherein: the first sequence of bits indicates the subset of additional ROs that are activated for use by the UE in the particular time intervals having the length greater than or equal to the threshold length; and the second sequence of bits indicates the subset of additional ROs that are activated for use by the UE in the particular time intervals having the length less than the threshold length.

Clause 18: The method of Clause 14, wherein: the first sequence of bits applies to even numbered time intervals of the one or more particular time intervals; and the second sequence of bits applies to odd numbered time intervals of the one or more particular time intervals.

Clause 19: The method of Clause 18, wherein: the first sequence of bits indicates the subset of additional ROs that are activated for use by the UE in the even numbered time intervals of the one or more particular time intervals; and the second sequence of bits indicates the subset of additional ROs that are activated for use by the UE in the odd numbered time intervals of the one or more particular time intervals.

Clause 20: A method for wireless communication by a network entity, comprising: transmitting, to a user equipment (UE), first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs; transmitting, to the UE, second RACH configuration information configuring a plurality of additional ROs in one or more RACH configuration periods of the plurality of RACH configuration periods, wherein the second RACH configuration information defines the plurality of additional ROs relative to the plurality of legacy ROs; transmitting, to the UE, downlink control information (DCI) indicating: a set of additional ROs from the plurality of additional ROs a subset of additional ROs that are activated, in the indicated set of additional ROs, for use by the UE; and receiving, from the UE, a RACH transmission in at least one legacy RO of the plurality of legacy ROs or in at least one additional RO of the subset of additional ROs that is activated for use by the UE.

Clause 21: The method of Clause 20, wherein: the set of additional ROs comprises a particular set of additional ROs corresponding to one or more particular time intervals; and the particular set of additional ROs comprises one of: a first set of additional ROs including all additional ROs corresponding to a system frame or RACH configuration period; a second set of additional ROs including all additional ROs corresponding to a RACH association pattern period; a third set of additional ROs including all additional ROs corresponding to a RACH association period; a fourth set of additional ROs including all additional ROs corresponding to a synchronization signal block (SSB)-to-RO mapping cycle; or a fifth set of additional ROs corresponding to all additional ROs mapped to a particular synchronization signal block (SSB).

Clause 22: The method of Clause 21, wherein the DCI includes a first set of bits that indicate the subset of additional ROs that are activated for use by the UE.

Clause 23: The method of Clause 22, wherein a quantity of the first set of bits is one of: semi-statically configured; dynamically indicated in the DCI; or indicated based on a function of a maximum number of additional ROs across all of the one or more particular time intervals.

Clause 24: The method of Clause 22, wherein a quantity of the first set of bits that indicate the subset of additional ROs that are activated for use by the UE implicitly indicates which particular set of additional ROs that the indicated set of additional ROs is.

Clause 25: The method of Clause 24, wherein: when the quantity of bits of the first set of bits is greater than or equal to a quantity of additional ROs in the first set of additional ROs, the quantity of bits of the first set of bits implicitly indicates that the set of additional ROs is the first set of additional ROs; when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs; and when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs; when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs; and when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

Clause 26: The method of Clause 22, further comprising transmitting a second set of bits that explicitly indicates which particular set of ROs that the indicated set of additional ROs is.

Clause 27: The method of Clause 26, wherein the second set of bits dynamically or semi-statically configures the set of additional ROs.

Clause 28: The method of Clause 27, wherein transmitting the second set of bits comprises transmitting the second set of bits in at least one of: the DCI; a radio resource control (RRC) message; or a media access control-control element (MAC-CE) message.

Clause 29: The method of Clause 22, wherein: the first set of bits that indicate the subset of additional ROs includes a bitmap comprising one or more bits; and each different bit of the one or more bits of the bitmap corresponds to a different additional RO in the set of additional ROs and indicates that that different additional RO is activated for use by the UE.

Clause 30: The method of Clause 22, further comprising receiving additional configuration information indicating how to interpret different combinations of the first set of bits to determine which additional ROs, from the set of additional ROs, are included in the subset of ROs.

Clause 31: The method of Clause 30, wherein the additional configuration information is semi-statically configured or fixed in a wireless communication standard.

Clause 32: The method of Clause 30, wherein the additional configuration information indicates, at least one of, that: for a first combination, all additional ROs of the set of additional ROs are included in the subset of additional ROs and are activated for use by the UE; for a second combination, only additional ROs from the set of additional ROs that are included in even numbered RACH configuration periods of the plurality of RACH configuration periods are included in the subset of additional ROs and are activated for use by the UE; or for a third combination, only additional ROs from the set of additional ROs that are included in odd numbered RACH configuration periods of the plurality of RACH configuration periods are included in the subset of additional ROs and are activated for use by the UE.

Clause 33: The method of Clause 22, wherein the first set of bits includes a first sequence of bits and a second sequence of bits.

Clause 34: The method of Clause 33, wherein the first sequence of bits and second sequence of bits apply to different particular time intervals of the one or more particular time intervals depending on lengths of the different particular time intervals.

Clause 35: The method of Clause 34, wherein: the first sequence of bits applies to particular time intervals of the one or more particular time intervals having a length greater than or equal to a threshold length; and the second sequence of bits applies to particular time intervals of the one or more particular time intervals having a length less than the threshold length.

Clause 36: The method of Clause 35, wherein: the first sequence of bits indicates the subset of additional ROs that are activated for use by the UE in the particular time intervals having the length greater than or equal to the threshold length; and the second sequence of bits indicates the subset of additional ROs that are activated for use by the UE in the particular time intervals having the length less than the threshold length.

Clause 37: The method of Clause 33, wherein: the first sequence of bits applies to even numbered time intervals of the one or more particular time intervals; and the second sequence of bits applies to odd numbered time intervals of the one or more particular time intervals.

Clause 38: The method of Clause 37, wherein: the first sequence of bits indicates the subset of additional ROs that are activated for use by the UE in the even numbered time intervals of the one or more particular time intervals; and the second sequence of bits indicates the subset of additional ROs that are activated for use by the UE in the odd numbered time intervals of the one or more particular time intervals.

Clause 39: An apparatus, comprising: at least one memory comprising executable instructions; and at least one processor configured to execute the executable instructions and cause the apparatus to perform a method in accordance with any combination of Clauses 1-38.

Clause 40: An apparatus, comprising means for performing a method in accordance with any combination of Clauses 1-38.

Clause 41: A non-transitory computer-readable medium comprising executable instructions that, when executed by at least one processor of an apparatus, cause the apparatus to perform a method in accordance with any combination of Clauses 1-38.

Clause 42: A computer program product embodied on a computer-readable storage medium comprising code for performing a method in accordance with any combination of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

Means for receiving and means for transmitting, and means for monitoring may comprise one or more processors, such as one or more of the processors described above with reference to FIGS. 14 and 15.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
one or more processors configured to execute instructions stored on one or more processors and to cause the UE to:
receive first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs;
receive second RACH configuration information configuring a plurality of additional ROs in one or more RACH configuration periods of the plurality of RACH configuration periods, wherein the second RACH configuration information defines the plurality of additional ROs relative to the plurality of legacy ROs;
receive downlink control information (DCI) indicating:
a set of additional ROs from the plurality of additional ROs; and
a subset of additional ROs that are activated, in the indicated set of additional ROs, for use by the UE; and
transmit a RACH transmission in at least one legacy RO of the plurality of legacy ROs or in at least one additional RO of the subset of additional ROs that is activated for use by the UE.

2. The UE of claim 1, wherein:
the set of additional ROs comprises a particular set of additional ROs corresponding to one or more particular time intervals; and
the particular set of additional ROs comprises one of:
a first set of additional ROs including all additional ROs corresponding to a system frame or RACH configuration period;
a second set of additional ROs including all additional ROs corresponding to a RACH association pattern period;
a third set of additional ROs including all additional ROs corresponding to a RACH association period;
a fourth set of additional ROs including all additional ROs corresponding to a synchronization signal block (SSB)-to-RO mapping cycle; or
a fifth set of additional ROs corresponding to all additional ROs mapped to a particular synchronization signal block (SSB).

3. The UE of claim 2, wherein the DCI includes a first set of bits that indicate the subset of additional ROs that are activated for use by the UE.

4. The UE of claim 3, wherein a quantity of the first set of bits is one of:
semi-statically configured;
dynamically indicated in the DCI; or
indicated based on a function of a maximum number of additional ROs across all of the one or more particular time intervals.

5. The UE of claim 3, wherein a quantity of the first set of bits that indicate the subset of additional ROs that are activated for use by the UE implicitly indicates which particular set of additional ROs that the indicated set of additional ROs is.

6. The UE of claim 5, wherein:
when the quantity of bits of the first set of bits is greater than or equal to a quantity of additional ROs in the first set of additional ROs, the quantity of bits of the first set of bits implicitly indicates that the set of additional ROs is the first set of additional ROs;
when the quantity of bits of the first set of bits is less than the quantity of additional ROs in the first set but greater than or equal to a quantity of additional ROs in the second set of additional ROs, the quantity of bits of the first set of bits implicitly indicates that the set of additional ROs is the second set of additional ROs; and
when the quantity of bits of the first set of bits is less than the quantity of additional ROs in the second set but greater than or equal to a quantity of additional ROs in the third set of additional ROs, the quantity of bits of the first set of bits implicitly indicates that the set of additional ROs is the third set of additional ROs;
when the quantity of bits of the first set of bits is less than the quantity of additional ROs in the third set but greater than or equal to a quantity of additional ROs in the fourth set of additional ROs, the quantity of bits of the first set of bits implicitly indicates that the set of additional ROs is the fourth set of additional ROs; and
when the quantity of bits of the first set of bits is less than the quantity of additional ROs in the fourth set but greater than or equal to a quantity of additional ROs in the fifth set of additional ROs, the quantity of bits of the first set of bits implicitly indicates that the set of additional ROs is the fifth set of additional ROs.

7. The UE of claim 3, wherein the one or more processors are further configured to cause the UE to receive a second set of bits that explicitly indicates which particular set of ROs that the indicated set of additional ROs is.

8. The UE of claim 7, wherein the second set of bits dynamically or semi-statically configures the set of additional ROs.

9. The UE of claim 8, wherein the one or more processors are configured to cause the UE to receive the second set of in at least one of:
the DCI;
a radio resource control (RRC) message; or
a media access control-control element (MAC-CE) message.

10. The UE of claim 3, wherein:
the first set of bits that indicate the subset of additional ROs includes a bitmap comprising one or more bits; and
each different bit of the one or more bits of the bitmap corresponds to a different additional RO in the set of additional ROs and indicates that that different additional RO is activated for use by the UE.

11. The UE of claim 3, further comprising receiving additional configuration information indicating how to interpret different combinations of the first set of bits to determine which additional ROs, from the set of additional ROs, are included in the subset of ROs.

12. The UE of claim 11, wherein the additional configuration information is semi-statically configured or fixed in a wireless communication standard.

13. The UE of claim 11, wherein the additional configuration information indicates, at least one of, that:
for a first combination, all additional ROs of the set of additional ROs are included in the subset of additional ROs and are activated for use by the UE;
for a second combination, only additional ROs from the set of additional ROs that are included in even numbered RACH configuration periods of the plurality of RACH configuration periods are included in the subset of additional ROs and are activated for use by the UE; or
for a third combination, only additional ROs from the set of additional ROs that are included in odd numbered RACH configuration periods of the plurality of RACH configuration periods are included in the subset of additional ROs and are activated for use by the UE.

14. The UE of claim 3, wherein the first set of bits includes a first sequence of bits and a second sequence of bits.

15. The UE of claim 14, wherein the first sequence of bits and second sequence of bits apply to different particular time intervals of the one or more particular time intervals depending on lengths of the different particular time intervals.

16. The UE of claim 15, wherein:
the first sequence of bits applies to particular time intervals of the one or more particular time intervals having a length greater than or equal to a threshold length; and
the second sequence of bits applies to particular time intervals of the one or more particular time intervals having a length less than the threshold length.

17. The UE of claim 16, wherein:
the first sequence of bits indicates the subset of additional ROs that are activated for use by the UE in the particular time intervals having the length greater than or equal to the threshold length; and
the second sequence of bits indicates the subset of additional ROs that are activated for use by the UE in the particular time intervals having the length less than the threshold length.

18. The UE of claim 14, wherein:
the first sequence of bits applies to even numbered time intervals of the one or more particular time intervals; and
the second sequence of bits applies to odd numbered time intervals of the one or more particular time intervals;
the first sequence of bits indicates the subset of additional ROs that are activated for use by the UE in the even numbered time intervals of the one or more particular time intervals; and
the second sequence of bits indicates the subset of additional ROs that are activated for use by the UE in the odd numbered time intervals of the one or more particular time intervals.

19. A method for wireless communication by a user equipment (UE), comprising:
receiving first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs;
receiving second RACH configuration information configuring a plurality of additional ROs in one or more RACH configuration periods of the plurality of RACH configuration periods, wherein the second RACH configuration information defines the plurality of additional ROs relative to the plurality of legacy ROs;
receiving downlink control information (DCI) indicating:
a set of additional ROs from the plurality of additional ROs; and
a subset of additional ROs that are activated, in the indicated set of additional ROs, for use by the UE; and
transmitting a RACH transmission in at least one legacy RO of the plurality of legacy ROs or in at least one additional RO of the subset of additional ROs that is activated for use by the UE.

20. A network entity, comprising:
one or more processors configured to execute instructions stored on one or more memories and to cause the network entity to:
transmit, to a user equipment (UE), first random access channel (RACH) configuration information configuring a plurality of RACH configuration periods and a plurality of legacy RACH occasions (ROs), wherein each RACH configuration period of the plurality of RACH configuration periods includes at least one legacy RO of the plurality of legacy ROs;
transmit, to the UE, second RACH configuration information configuring a plurality of additional ROs in one or more RACH configuration periods of the plurality of RACH configuration periods, wherein the second RACH configuration information defines the plurality of additional ROs relative to the plurality of legacy ROs;
transmit, to the UE, downlink control information (DCI) indicating:
a set of additional ROs from the plurality of additional ROs; and
a subset of additional ROs that are activated, in the indicated set of additional ROs, for use by the UE; and
receive, from the UE, a RACH transmission in at least one legacy RO of the plurality of legacy ROs or in at least one additional RO of the subset of additional ROs that is activated for use by the UE.
